(19) United States
(12) Patent Application Publication
(10) Pub. No.: US 2022/0357102 A1
(43) Pub. Date: Nov. 10, 2022

(54) METHOD AND APPARATUS FOR FORMING SOLID CARBON DIOXIDE

(71) Applicant: Cold Jet, LLC, Loveland, OH (US)

(72) Inventor: Henrik Hansen, Bramming (DK)

(21) Appl. No.: 17/738,389

(22) Filed: May 6, 2022

Related U.S. Application Data
(60) Provisional application No. 63/185,467, filed on May 7, 2021.

(51) Int. Cl. F25J 1/00; C01B 32/55

(52) U.S. Cl. CPC F25J 1/0027; F25J 1/003; C01B 32/55; F25J 2205/20

(57) ABSTRACT

An apparatus for forming solid carbon dioxide blocks comprises a chamber with an internal cavity, a flow control valve including a variable area orifice, an actuator configured to control the area of the variable area orifice and a controller configured to vary the are of the variable area orifice while liquid carbon dioxide is being flashed to solid carbon dioxide snow through the flow control valve. A method of forming carbon dioxide blocks comprises the steps of varying the area of an orifice while flowing liquid carbon dioxide through the orifice under sufficient pressure to flash the liquid carbon dioxide to solid carbon dioxide snow.

### TECHNICAL FIELD

The present innovation relates to transforming liquid cryogenic material into solid cryogenic material, and is particularly directed to a method and apparatus for forming solid carbon dioxide from liquid. The innovation will be disclosed specifically disclosed in connection with a servo motor controlled flow valve.

### BACKGROUND

Carbon dioxide systems, including systems for creating solid carbon dioxide blocks and slabs, are well known, and along with various associated component parts, much of which is shown in U.S. Pat. Nos. 4,744,181, 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,524,172, 6,695,679, 6,695,685, 6,726,549, 6,739,529, 6,824,450, 7,112,120, 7,950,984, 8,187,057, 8,277,288, 8,869,551, 9,095,956, 9,592,586, 9,931,639 and 10,315,862 all of which are incorporated herein in their entirety by reference. Additionally, U.S. patent application Ser. No. 11/853,194, filed Sep. 11, 2007, for Particle Blast System With Synchronized Feeder and Particle Generator US Pub. No. 2009/0093196; U.S. Provisional Patent Application Ser. No. 61/589,551 filed Jan. 23, 2012, for Method And Apparatus For Sizing Carbon Dioxide Particles; U.S. Provisional Patent Application Ser. No. 61/592,313 filed Jan. 30, 2012, for Method And Apparatus For Dispensing Carbon Dioxide Particles; U.S. patent application Ser. No. 13/475,454, filed May 18, 2012, for Method And Apparatus For Forming Carbon Dioxide Pellets; U.S. patent application Ser. No. 14/062,118 filed Oct. 24, 2013 for Apparatus Including At Least An Impeller Or Diverter And For Dispensing Carbon Dioxide Particles And Method Of Use US Pub. No. 2014/0110510; U.S. patent application Ser. No. 14/516,125, filed Oct. 16, 2014, for Method And Apparatus For Forming Solid Carbon Dioxide US Pub. No. 2015/0166350; U.S. patent application Ser. No. 15/297,967, filed Oct. 19, 2016, for Blast Media Comminutor US Pub. No. 2017/0106500; U.S. patent application Ser. No. 15/961,321, filed Apr. 24, 2018 for Particle Blast Apparatus; and U.S. Provisional patent application Ser. No. 16/999,633, filed Aug. 21, 2020, for Particle Blast Apparatus and Method, are all incorporated herein in their entirety by reference.

Although this patent refers specifically to carbon dioxide in explaining the innovation, the innovation is not limited to carbon dioxide but rather may be applied to any suitable cryogenic material. Thus, references to carbon dioxide herein, including in the claims, are not to be limited to carbon dioxide but are to be read to include any suitable cryogenic material.

Solid cryogenic material, such as solid carbon dioxide, may be formed by many ways. Such solid particles may be formed by transforming liquid carbon dioxide into small solid particles (“snow”) via phase change, and forming that snow into solid blocks, also called slabs or slices by compressing the snow. To convert carbon dioxide from the liquid state to the solid state as snow, pressurized liquid CO₂ is passed through an orifice and flashed to snow.

When subsequent cyclical processing the solid CO₂ snow is to occur, such as compressing the snow to form solid blocks or slabs, the conversion of liquid CO₂ must also be cyclical, requiring a flow control valve which is cyclically opened and closed. It is known to use the flow control valve to function to flash the liquid CO₂ to snow.

The yield, efficiency and productivity of the process of cyclically converting CO₂ to snow is affected by the function of the flow control valve, particularly the speed of operation and the precision of the valve position. The reaction time of prior art pneumatically controlled flow control valves has a negative impact on the cycle time, and the reaction time increases over time as the pneumatic actuator becomes worn. The prior art pneumatically actuated flow control valve lacks accurate positioning of and the ability to variably position the flow control valve's orifice.

### BRIEF DESCRIPTION OF THE DRAWINGS

The accompanying drawings, which are incorporated in and constitute a part of this specification, illustrate embodiments, and, together with the general description of the invention given above, and the detailed description of the embodiments given below, serve to explain the principles of the present innovation.

FIG. 1 is a diagrammatic side view of an apparatus for forming for forming solid blocks of carbon dioxide constructed in accordance with the teachings of the present disclosure.

FIG. 2 is an exploded illustration of the actuator and flow control valve of FIG. 1.

FIG. 3 is an enlarged illustration of the ball of the flow control valve.

FIG. 4A illustrates an opening profile of the present innovation.

FIG. 4B illustrates an opening profile of the prior art pneumatic actuator.

Reference will now be made to one or more embodiments illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations.

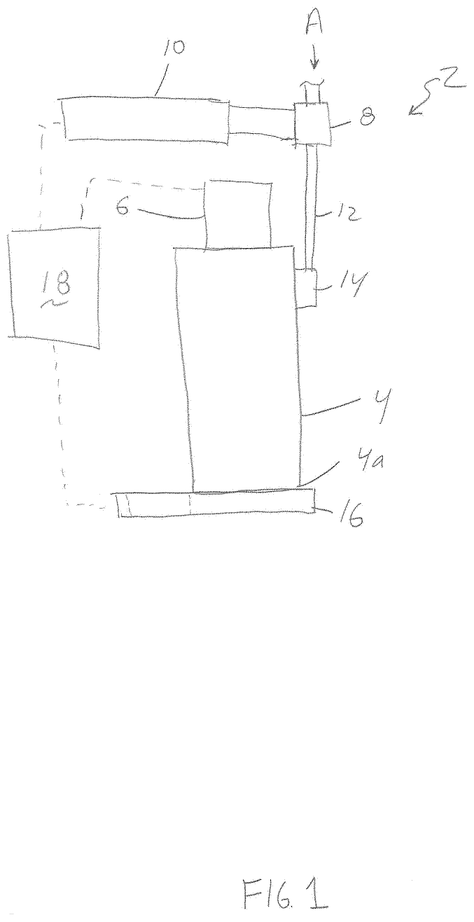

Referring to FIG. 1, there is diagrammatically shown an apparatus, generally indicated at 2, for forming carbon dioxide blocks. Apparatus 2 comprises chamber 4, compression assembly 6, flow control valve 8, actuator 10, tube 12, inlet housing 14 and plate 16. As is well known, chamber 4 defines an internal cavity of any suitable cross-sectional shape. An axially reciprocable piston (not shown) is disposed within the internal cavity. Compression assembly 6 is connected to and effects movement of the piston within the internal cavity. Controller 18 controls the operation of apparatus 2, being connected (as diagrammatically indicated) to compression assembly 6, flow control valve 8 and plate 16.

To form carbon dioxide blocks, pressurized liquid carbon dioxide is delivered to the inlet of a flow control valve 8 from a source of pressurized liquid carbon dioxide, indicated by A. Actuator 10 effects the opening and closing of flow control valve 8, including controlling the position of the valve (described below). When flow control valve 8 is open, liquid carbon dioxide flashes to carbon dioxide snow as it flows through the orifice of flow control valve 8. The snow flows out the outlet of flow control valve 8 into the inlet of a flow passageway and out the outlet of the flow passageway into the internal cavity of chamber 4. In the embodiment depicted, the flow passageway is defined by tube 12 and inlet housing 14 which is in fluid communication with the internal cavity of chamber 4. When a desired amount of snow is in the internal cavity of chamber 4, controller 18 will control actuator 10 to stop the flow and will control compression assembly 6 to advance the piston axially through the internal cavity of chamber 4 so as to exert sufficient force on the snow to form a carbon dioxide block adjacent plate 16. After the carbon dioxide block has been formed, controller 18 will cause plate 16 to move so that the carbon dioxide block is ejected out of end 4a of chamber 4. This cycle is repeated to form additional carbon dioxide blocks.

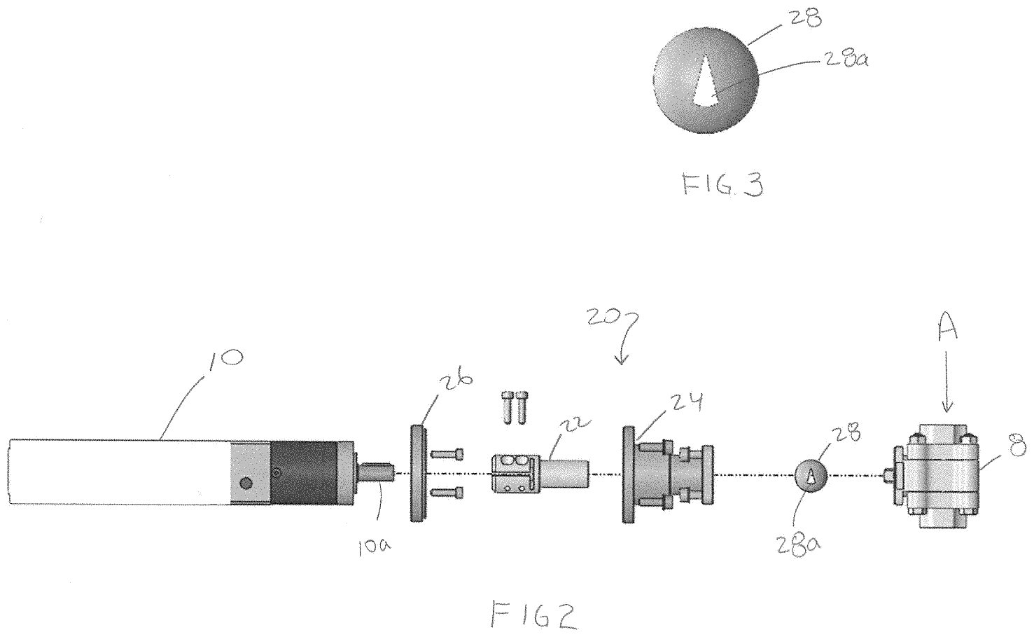

Referring also to FIGS. 2 and 3, there is shown an exploded illustration of flow control valve 8, actuator 10 and extension assembly 20. Extension assembly 20 includes extension 22, housing 24 and retainer 26. Extension 22 insulates actuator 10 from the cold of flow control valve 8. Extension 22 is connected to output 10a of actuator 10 and disposed in housing 24. Housing 24 is connected to retainer 26 which retains extension assembly 20 to actuator 20. Housing 24 is also connected to flow control valve 8.

In FIG. 2, ball 28 is illustrated next to flow control valve 8 for illustrative purposes, it being understood that ball 28 is disposed within flow control valve 8 adjacent the valve seats/seals (not illustrated). FIG. 3 illustrates an enlarged view of ball 28. Ball 28 includes orifice 28a which is, in the embodiment depicted, V shaped. The included angle of the V shape may by any suitable angle, such as 10° to 35°. Upstream of ball 28 is the pressurized liquid carbon dioxide. As it flows through orifice 28a, the liquid carbon dioxide flashes to carbon dioxide snow and to carbon dioxide gas.

Not all of orifice 28a is exposed to the flow. Actuator may orient orifice 28a at variable positions of occlusion relative to the valve seats. The unoccluded area of orifice 28a determines the flow rate and conversion of the carbon dioxide flowing therethrough.

In the depicted embodiment illustrating the present innovation, actuator 10 is a servo motor, which does not have the response time lag of the prior art pneumatic actuators: The lag time is much less than the typical 100 msec response time lag of the prior art, and does not vary. With the servo motor actuated flow control valve 8, the opening angle of flow control valve 8, and thus the orientation of orifice 28a, may be precisely controlled. Intermediate positions between fully closed and fully open may be achieved. In the depicted embodiment, actuator 10 may be a multiturn servo motor.

The servo motor actuator allows the orientation of orifice 28a to be controlled and adjusted on the fly, and re-set through reprogramming of controller 18. The servo motor actuator allows the injection time to be short and precise. Thus, even through the pressure and temperature of the liquid carbon dioxide changes during operation, the charge of snow disposed within chamber 4 for each cycle can be controlled to be constant.

Controller 18 may comprise a processor and be configured to control the orientation of orifice 28a (such as via controlling actuator 10) based on various operational parameters of apparatus 2. Controller 18 may receiver input values from sensors of the apparatus 2. One or more sensors may be use to provide information to controller 18 as to, by way of non-limiting example, the pressure in chamber 4 during injection, the liquid CO₂ flow rate during injection, the liquid CO₂ pressure during injection (which may be sensed proximal to or at the inlet of the flow control valve) and the liquid CO2 temperature during injection (which may be sensed proximal to or at the inlet of the flow control valve).

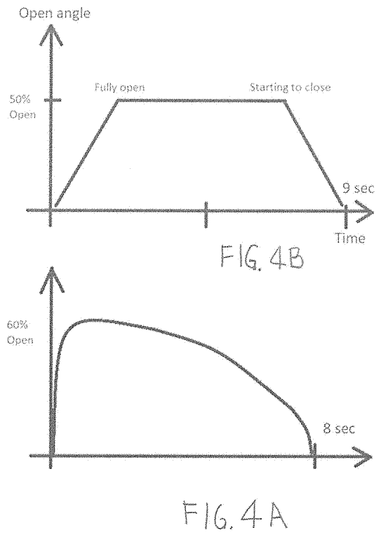

Referring to FIG. 4A, there is shown an opening profile which can be attained with the present innovation using a servo motor actuator. FIG. 4B illustrates an opening profile attained by the prior art pneumatic actuator. As illustrated, the present innovation achieves the desired/programmed open angle nearly instantaneously, and the angle can be varied over time to allow the cycle time to be less. The opening percentage depends on characteristics of chamber 4, and is typically controlled not to reach 100%.

### Explicit Definitions

“Based on” means that something is determined at least in part by the thing that it is indicated as being “based on.” When something is completely determined by a thing, it will be described as being “based exclusively on” the thing.

“Processor” means devices which can be configured to perform the various functionality set forth in this disclosure, either individually or in combination with other devices. Examples of “processors” include microprocessors, microcontrollers, digital signal processors (DSPs), field programmable gate arrays (FPGAs), programmable logic devices (PLDs), programmable logic controllers (PLCs), state machines, gated logic, and discrete hardware circuits. The phrase “processing system” is used to refer to one or more processors, which may be included in a single device, or distributed among multiple physical devices.

A statement that a processing system is “configured” to perform one or more acts means that the processing system includes data (which may include instructions) which can be used in performing the specific acts the processing system is “configured” to do. For example, in the case of a computer (a type of “processing system”) installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

The foregoing description of one or more embodiments of the innovation has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the innovation and its practical application to thereby enable one of ordinary skill in the art to best utilize the innovation in various embodiments and with various modifications as are suited to the particular use contemplated. Although only a limited number of embodiments of the innovation is explained in detail, it is to be understood that the innovation is not limited in its scope to the details of construction and arrangement of components set forth in the preceding description or illustrated in the drawings. The innovation is capable of other embodiments and of being practiced or carried out in various ways. Also, specific terminology was used for the sake of clarity. It is to be understood that each specific term includes all technical equivalents which operate in a similar manner to accomplish a similar purpose. It is intended that the scope of the invention be defined by the claims submitted herewith.

1. An apparatus for forming carbon dioxide blocks, comprising:
a. a chamber comprising an internal cavity
b. a flow control valve configured to flash liquid carbon dioxide flowing therethrough to solid carbon dioxide, the flow control valve comprising an inlet and an outlet, and a variable area orifice, the inlet configured to receive liquid carbon dioxide from a source of pressurized liquid carbon dioxide;
c. a flow passageway comprising an inlet and an outlet, the inlet in fluid communication with the flow control valve outlet and the outlet in fluid communication with the internal cavity;
d. an actuator connected to the flow control valve and configured to control the area of the variable area orifice; and
e. a controller configured to vary the area of the variable area orifice while liquid carbon dioxide is flowing through the flow control valve.

2. The apparatus of claim 1, wherein the controller varies the area of the variable area orifice by controlling the actuator.

3. The apparatus of claim 1, wherein the actuator is a servo motor.

4. The apparatus of claim 1, wherein the controller is configured to vary the area of the variable area orifice based on at least one operating parameter of the apparatus.

5. The apparatus of claim 4, wherein the at least one operating parameter comprises one or more of the group consisting of pressure in the chamber, flow rate of liquid carbon dioxide through the flow control valve, pressure of liquid carbon dioxide upstream of the variable area orifice and temperature of liquid carbon dioxide.

6. The apparatus of claim 4, comprising a respective sensor to determine each of the at least one operating parameter.

7. The apparatus of claim 1, comprising an thermal insulator which insulates the actuator from the flow control valve.

8. The apparatus of claim 1, comprising a cyclically reciprocable piston disposed within the internal cavity and a compression assembly configured to effect movement of the piston within the internal cavity.

9. The apparatus of claim 8, wherein the controller is configured to control the operation of the compression assembly.

10. A method of forming carbon dioxide blocks comprising the steps of:
a. flowing liquid carbon dioxide through an orifice under sufficient pressure to flash the liquid carbon dioxide to solid carbon dioxide snow, wherein the orifice has a variable area; and
b. varying the area of the orifice during the step of flowing liquid carbon dioxide through the orifice.

11. The method of claim 10, wherein the step of varying the area of the orifice comprises controlling the area of orifice based on at least one operating parameter of the method.

12. The method of claim 11, wherein the at least one operating parameter comprises one or more of the group consisting of flow rate of the liquid carbon dioxide, pressure of the liquid carbon dioxide upstream of the orifice and temperature of the liquid carbon dioxide.

13. The method of claim 11, comprising the step of flowing the solid carbon dioxide snow into an internal cavity, and wherein the at least one operating wherein the at least one operating parameter comprises one or more of the group consisting of pressure in the internal cavity, flow rate of the liquid carbon dioxide, pressure of the liquid carbon dioxide upstream of the orifice and temperature of the liquid carbon dioxide.

14. The method of claim 10, comprising the steps of accumulating a desired amount of solid carbon dioxide snow and compressing the solid carbon dioxide snow to form a carbon dioxide block.
